(19) United States
(12) Patent Application Publication
(10) Pub. No.: US 2017/0249018 A1
(43) Pub. Date: Aug. 31, 2017

(54) KEY FUNCTION CONTROL METHOD AND TERMINAL

(71) Applicant: GIONEE COMMUNICATION EQUIPMENT CO.,LTD. SHENZHEN, Shenzhen (CN)

(72) Inventors: Jinwu HUANG, Shenzhen (CN); Xiangling ZHONG, Shenzhen (CN)

(73) Assignee: GIONEE COMMUNICATION EQUIPMENT CO.,LTD. SHENZHEN, Shenzhen (CN)

(21) Appl. No.: 15/507,242

(22) PCT Filed: Jul. 17, 2015
(86) PCT No.: PCT/CN2015/084286

§ 371 Date: Feb. 27, 2017

(30) Foreign Application Priority Data
Aug. 27, 2014 (CN) 201410428785.2
Aug. 27, 2014 (CN) 201410428816.4

(51) Int. Cl. G06F 3/023; H04M 1/725; G06F 3/0488; G06F 3/0482; G06F 3/0489

(52) U.S. Cl. CPC G06F 3/0238; G06F 3/0482; G06F 3/0489; G06F 3/04886; H04M 1/72519

(57) ABSTRACT

Disclosed are a key function control method and a terminal. The method comprises: monitoring an operation on a first key of a terminal, wherein the operation on the first key at least can trigger a primary function and a secondary function, and the primary function refers to a preset logical function corresponding to the operation on the first key; determining whether the operation on the first key can trigger execution of the primary function according to output of a user interface of the terminal; and if not, controlling to execute the secondary function. Also disclosed is a corresponding terminal.

### CROSS REFERENCE TO RELATED APPLICATIONS

The present application claims priority to Chinese Patent Application No. 201410428816.4, filed with the Chinese Patent Office on Aug. 27, 2014 and entitled “KEY FUNCTION CONTROL METHOD”, and Chinese Patent Application No. 201410428785.2, filed with the Chinese Patent Office on Aug. 27, 2014 and entitled “TERMINAL”, contents of both of which are hereby incorporated by reference in their entireties.

### TECHNICAL FIELD

The present disclosure relates to a technical field of smart terminals, and in particular, to a key function control method and a terminal.

### BACKGROUND

Currently, a portable smart terminal, such as a mobile phone, has a large screen on which keys, such as a menu key, a return key and so forth have fixed locations, such that it is difficult and inconvenient for a user to operate with a single hand.

Therefore, how to enable the operations on the keys to be flexible becomes a problem which should be solved currently.

### SUMMARY

The present disclosure proposes a key function control method and a terminal by which the key functions are controlled and a user can operate keys on the terminal flexibly.

According to one aspect, a key function control method is provided and comprises: monitoring an operation on a first key of a terminal, wherein the operation on the first key at least can trigger a primary function and a secondary function, and the primary function refers to a preset logical function corresponding to the operation on the first key; determining whether the operation on the first key can trigger execution of the primary function according to output of a user interface of the terminal; and controllably executing the secondary function if it is determined that the operation on the first key cannot trigger the execution of the primary function.

According to another aspect, a terminal is provided and comprises: a monitoring unit configured to monitor an operation on a first key of a terminal, wherein the operation on the first key at least can trigger a primary function and a secondary function, and the primary function refers to a preset logical function corresponding to the operation on the first key; a determining unit configured to determine whether the operation on the first key can trigger execution of the primary function according to output of a user interface of the terminal; and a control unit configured to controllably execute the secondary function if it is determined that the operation on the first key cannot trigger the execution of the primary function.

By means of the key function control method and the terminal according to the embodiments of the present disclosure, at least two-level functions can be triggered through the setting of one key, and the secondary function is executed when it is determined that the primary function cannot be executed, so that the key functions are controlled and a user can operate keys on the terminal flexibly.

### BRIEF DESCRIPTION OF DRAWINGS

In order to more clearly describe technical solutions in embodiments of the present disclosure or prior art, the accompanying drawings used for describing the embodiments or prior art will be briefly introduced hereinafter. Apparently, the accompanying drawings described hereinafter merely show some embodiments of the present disclosure, and persons skilled in the art may also derive other drawings from these accompanying drawings without creative efforts.

FIG. 1 is a flowchart of a key function control method according to an embodiment of the present disclosure;

FIG. 2 is a flowchart of another key function control method according to an embodiment of the present disclosure;

FIG. 3 is a flowchart of yet another key function control method according to an embodiment of the present disclosure;

FIG. 4 is a schematic structural diagram of a terminal according to an embodiment of the present disclosure;

FIG. 5 is a schematic structural diagram of another terminal according to an embodiment of the present disclosure;

FIG. 6 is a schematic structural diagram of yet another terminal according to an embodiment of the present disclosure.

### DETAILED DESCRIPTION

In conjunction with the drawings in the embodiments of the present disclosure, a clear, complete description for the technical solutions in the embodiments of the present disclosure is provided below. Apparently, the described embodiments are a part rather than all of the embodiments of the present disclosure. All other embodiments obtained by persons skilled in the art according to the embodiments of the present disclosure without creative efforts should fall within the protection scope of the present disclosure.

A terminal according to an embodiment of the present disclosure may include a smart phone, a tablet computer, and so forth.

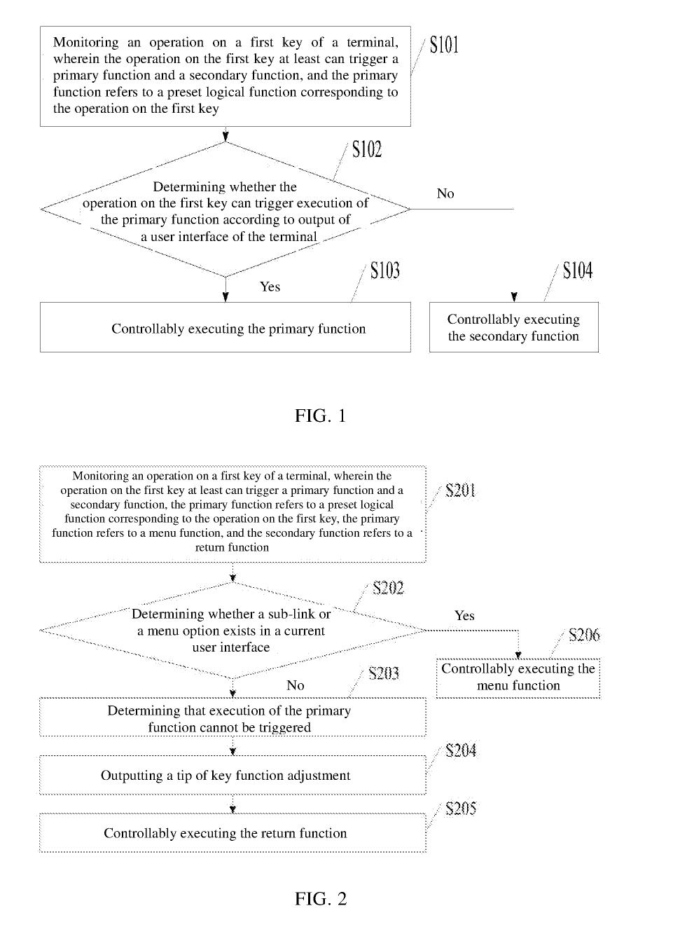

Referring to FIG. 1 illustrating a flowchart of a key function control method according to an embodiment of the present disclosure, the method includes following steps.

Step S101: an operation on a first key of a terminal is monitored. The operation on the first key at least can trigger a primary function and a secondary function, and the primary function refers to a preset logical function corresponding to the operation on the first key.

A current smart terminal, such as a mobile phone may have several conventional functional keys. The keys may be physical keys or virtual keys, such as a menu key, a return key and so forth. In addition, the current mobile phone is generally a phone having a large screen, while the conventional functional keys are arranged symmetrically about a perpendicular bisector in a length direction or a width direction of the terminal, for example, the menu key and the return key are symmetrically arranged on the left and right sides of the mobile phone, or naturally, they may also be arranged vertically symmetrically. In general, a user cannot operate two keys symmetrically arranged with a single hand.

Each of steps of operations which are to be performed and relates to these keys is preset by a terminal program, and can be adjusted by the program. Each of the keys according to the present embodiment has a preset logic function, i.e. a primary function. In common cases, the operation on the key triggers the first primary function, however, under certain conditions, the key can trigger a secondary function. The secondary function may be a preset logic function of a second key, while the first key and the second key are arranged symmetrically about a perpendicular bisector in a length direction or a width direction of the terminal.

The user can perform various operations on the terminal. In this step, the operation on the first key is monitored, and step S102 is performed when the operation on the first key has been monitored.

Step S102: whether the operation on the first key can trigger execution of the primary function is determined according to output of a user interface of the terminal. If so, step S103 is performed; and if not, step S104 is performed.

Sometimes, the preset logic function of the key may not include any operations to be performed subsequently. After the operation on the first key is monitored, whether the execution of the preset logic function of the first key can be triggered is determined according to the output of the user interface of the terminal. For example, for the menu key, sometimes no sub-links or menu options exist in the current user interface, and in this case, there is no response when the menu key is pressed; or, for the return key, if the current user interface is a starting interface or an unlocking interface, there is no response when the return key is pressed.

Step S103: the primary function is controllably executed.

If the first key is pressed, and that the operation on the first key can trigger the execution of the primary function is determined according to the output of the user interface of the terminal, the primary function is controllably executed.

Step S104: the secondary function is controllably executed.

If the first key is pressed, and that the operation on the first key cannot trigger the execution of the primary function is determined according to the output of the user interface of the terminal, the secondary function is controllably executed.

For example, in the case where there is no response when the menu key is pressed, if the user only wants to return to the previous menu or exit the application instead of returning to the main menu, the function of the menu key is adjusted to be a return function. In this way, the return function is executed only if the user presses the menu key, thereby facilitating the operation of the user, although the mobile phone with a large screen may not be operated with a single hand.

Thus, by means of the key function control method according to the embodiment of the present disclosure, at least two-level functions can be triggered through the setting of one key, and the secondary function is executed when it is determined that the primary function cannot be executed, so that the key functions are controlled and the user can operate keys on the terminal flexibly.

Referring to FIG. 2 illustrating a flowchart of another key function control method according to an embodiment of the present disclosure, the method includes following steps.

Step S201: an operation on a first key of a terminal is monitored. The operation on the first key at least can trigger a primary function and a secondary function, and the primary function refers to a preset logical function corresponding to the operation on the first key. The primary function refers to a menu function, and the secondary function refers to a return function.

Herein, the first key may be a menu key, while the primary function is the menu function and the secondary function is the return function, i.e. the function of the return key. The menu key and the return key are generally arranged symmetrically on the terminal.

In this step, the operation on the menu key is monitored.

Step S202: whether a sub-link or a menu option exists in a current user interface is determined. If so, step S206 is performed; and if not, step S203 is performed.

Step S203: it is determined that execution of the primary function cannot be triggered.

Step S204: a tip of key function adjustment is output.

Step S205: the return function is controllably executed.

Step S206: the menu function is controllably executed.

For the menu key, sometimes no sub-links or menu options exist in the current user interface, and at this time, there is no response when the menu key is pressed, i.e. the menu function cannot be executed. When the user only wants to return to the previous menu or exit the application instead of returning to the main menu, the mobile phone with a large screen may not be operated with a single hand, if the part of the mobile phone held by the single hand is far away from the return key. In this case, a tip of key function adjustment is output to prompt the user to continue to press the menu key, however, the secondary function of the menu key is executed. A mode of outputting the tip may be changing the backlight of the menu key or outputting a text or voice tip in the user interface. When the user presses the menu key again, the return function is executed to return to the previous menu or exit the application.

If it is determined that a sub-link or a menu option exists when the menu key is currently pressed, the menu function is still executed.

Thus, by means of the key function control method according to the embodiment of the present disclosure, at least two-level functions can be triggered through the setting of one key, and the secondary function is executed when it is determined that the primary function cannot be executed, so that the key functions are controlled and the user can operate keys on the terminal flexibly. And the tip of key function adjustment is further output, so as to prompt the user that the key has a function of function control, thereby facilitating the operation of the user.

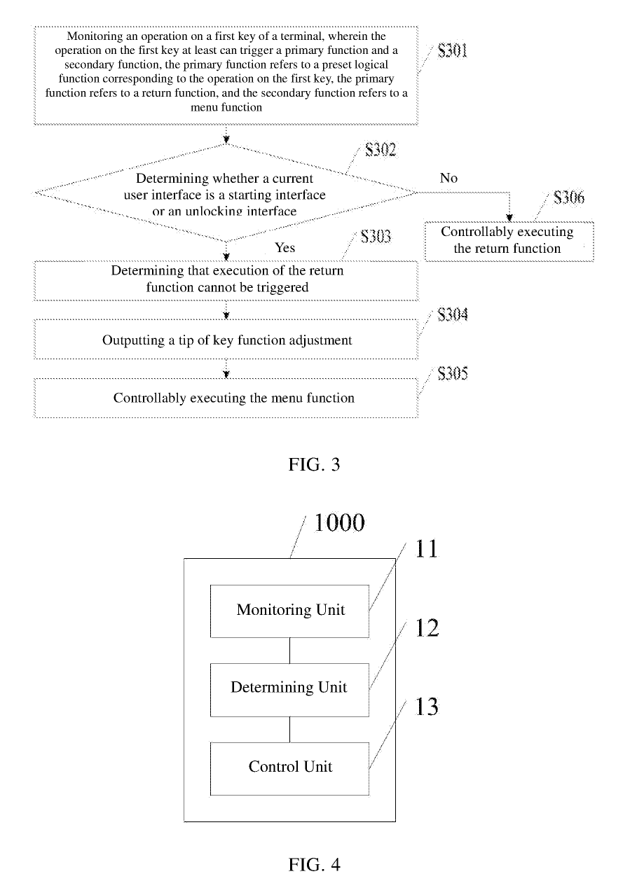

Referring to FIG. 3 illustrating a flowchart of yet another key function control method according to an embodiment of the present disclosure, the method includes following steps.

Step S301: an operation on a first key of a terminal is monitored. The operation on the first key at least can trigger a primary function and a secondary function, and the primary function refers to a preset logical function corresponding to the operation on the first key. The primary function refers to a return function, and the secondary function refers to a menu function.

Herein, the first key may be a return key, while the primary function is the return function and the secondary function is the menu function, i.e. the function of the menu key. The menu key and the return key are generally arranged symmetrically on the terminal.

In this step, the operation on the return key is monitored.

Step S302: whether a current user interface is a starting interface or an unlocking interface is determined. If so, step S303 is performed; if not, step S306 is performed.

Step S303: it is determined that execution of the return function cannot be triggered.

Step S304: a tip of key function adjustment is output.

Step S305: the menu function is controllably executed.

Step S306: the return function is controllably executed.

For example, if the current user interface is a starting interface or an unlocking interface, the return function cannot be executed when the return key is pressed. Thus, it is determined that the return function cannot be executed when the return key is pressed. At this time, a tip of key function adjustment is output to prompt the user to continue to press the return key, however, the secondary function of the return key is executed. A mode of outputting the tip may be changing the backlight of the return key or outputting a text or voice tip in the user interface. When the user presses the return key again, the menu function is executed. If the current user interface is not a starting interface or an unlocking interface, the return function is still executed when the return key is pressed.

Thus, by means of the key function control method according to the embodiment of the present disclosure, at least two-level functions can be triggered through the setting of one key, and the secondary function is executed when it is determined that the primary function cannot be executed, so that the key functions are controlled and the user can operate keys on the terminal flexibly. And the tip of key function adjustment is further output, so as to prompt the user that the key has a function of function control, thereby facilitating the operation of the user.

Referring to FIG. 4 illustrating a schematic structural diagram of a terminal according to an embodiment of the present disclosure, the terminal 1000 includes following units.

A monitoring unit 11 is configured to monitor an operation on a first key of a terminal. The operation on the first key at least can trigger a primary function and a secondary function, and the primary function refers to a preset logical function corresponding to the operation on the first key.

A current smart terminal, such as a mobile phone may have several conventional functional keys. The keys may be physical keys or virtual keys, such as a menu key, a return key and so forth. In addition, the current mobile phone is generally a phone having a large screen, while the conventional functional keys are arranged symmetrically about a perpendicular bisector in a length direction or a width direction of the terminal, for example, the menu key and the return key are symmetrically arranged on the left and right sides of the mobile phone, or naturally, they may also be arranged vertically symmetrically. In general, a user cannot operate two keys symmetrically arranged with a single hand.

Each of steps of operations which are to be performed and relates to these keys is preset by a terminal program, and can be adjusted by the program. Each of the keys according to the present embodiment has a preset logic function, i.e. a primary function. In common cases, the operation on the key triggers the first primary function, however, under certain conditions, the key can trigger a secondary function. The secondary function may be a preset logic function of a second key, while the first key and the second key are arranged symmetrically about a perpendicular bisector in a length direction or a width direction of the terminal.

The user can perform various operations on the terminal. The monitoring unit 11 monitors the operation on the first key, and when the operation on the first key has been monitored, a signal is output to a determining unit 12.

The determining unit 12 is configured to determine whether execution of the primary function can be triggered, according to output of a user interface of the terminal.

Sometimes, the preset logic function of the key may not include any operations to be performed subsequently. After the operation on the first key is monitored, the determining unit 12 determines whether the execution of the preset logic function of the first key can be triggered, according to the output of the user interface of the terminal. For example, for the menu key, sometimes no sub-links or menu options exist in the current user interface, and in this case, there is no response when the menu key is pressed; or, for the return key, if the current user interface is a starting interface or an unlocking interface, there is no response when the return key is pressed.

A control unit 13 is configured to controllably execute the secondary function if it is determined that the execution of the primary function cannot be triggered.

If the first key is pressed, and that the operation on the first key cannot trigger the execution of the primary function is determined according to the output of the user interface of the terminal, the control unit 13 controllably executes the secondary function.

The control unit 13 is further configured to controllably execute the primary function if it is determined that the execution of the primary function can be triggered.

If the first key is pressed, and that the operation on the first key can trigger the execution of the primary function is determined according to the output of the user interface of the terminal, the control unit 13 controllably executes the primary function.

For example, in the case where there is no response when the menu key is pressed, if the user only wants to return to the previous menu or exit the application instead of returning to the main menu, the function of the menu key is adjusted to be a return function. In this way, the return function is executed only if the user presses the menu key, thereby facilitating the operation of the user, although the mobile phone with a large screen may not be operated with a single hand.

Thus, by means of the terminal according to the embodiment of the present disclosure, at least two-level functions can be triggered through the setting of one key, and the secondary function is executed when it is determined that the primary function cannot be executed, so that the key functions are controlled and the user can operate keys on the terminal flexibly.

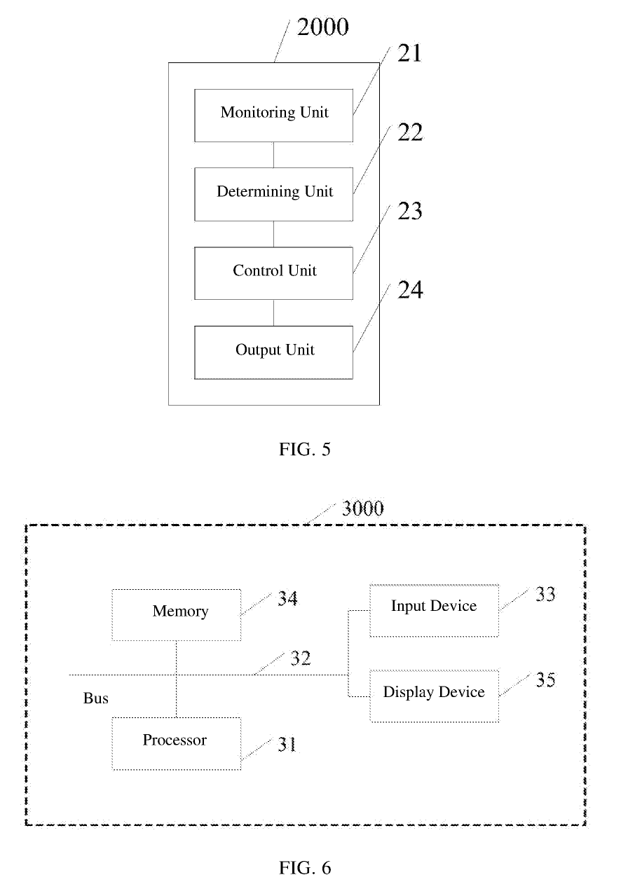

Referring to FIG. 5 illustrating a schematic structural diagram of another terminal according to an embodiment of the present disclosure, the terminal 2000 includes following units.

A monitoring unit 21 is configured to monitor an operation on a first key of a terminal. The operation on the first key at least can trigger a primary function and a secondary function, and the primary function refers to a preset logical function corresponding to the operation on the first key. The primary function refers to a menu function, and the secondary function refers to a return function.

Herein, the first key may be a menu key, while the primary function is the menu function and the secondary function is the return function, i.e. the function of the return key. The menu key and the return key are generally arranged symmetrically on the terminal.

The monitoring unit 21 monitors the operation on the menu key.

A determining unit 22 is configured to determine whether the operation on the first key can trigger execution of the primary function, according to output of a user interface of the terminal.

In at least one embodiment, the determining unit 22 is configured to determine whether a sub-link or a menu option exists in the current user interface; and if not, determine that the primary function cannot be executed.

A control unit 23 is configured to controllably execute the secondary function if it is determined that the operation on the first key cannot trigger the execution of the primary function.

The control unit 23 is further configured to controllably execute the primary function if it is determined that the operation on the first key can trigger the execution of the primary function.

In at least one embodiment, the control unit 23 is configured to controllably execute the return function if it is determined that no sub-links or menu options exist in the current user interface.

An output unit 24 is configured to output a tip of key function adjustment.

For the menu key, sometimes no sub-links or menu options exist in the current user interface, and at this time, there is no response when the menu key is pressed, i.e. the menu function cannot be executed. When the user only wants to return to the previous menu or exit the application instead of returning to the main menu, the mobile phone with a large screen may not be operated with a single hand, if the part of the mobile phone held by the single hand is far away from the return key. In this case, the output unit 24 outputs a tip of key function adjustment to prompt the user to continue to press the menu key, however, the secondary function of the menu key is executed. A mode of outputting the tip may be changing the backlight of the menu key or outputting a text or voice tip in the user interface. When the user presses the menu key again, the return function is executed to return to the previous menu or exit the application.

If it is determined that a sub-link or a menu option exists when the menu key is currently pressed, the menu function is still executed.

The monitoring unit 21 is further configured to monitor an operation on a first key of a terminal. The operation on the first key at least can trigger a primary function and a secondary function, and the primary function refers to a preset logical function corresponding to the operation on the first key. The primary function refers to a return function, and the secondary function refers to a menu function.

Herein, the first key may be a return key, while the primary function refers to the return function and the secondary function refers to the menu function, i.e. the function of the menu key. The menu key and the return key are generally arranged symmetrically on the terminal.

The monitoring unit 21 is configured to monitor the operation on the return key.

In at least one embodiment, the determining unit 22 is configured to determine whether a current user interface is a starting interface or an unlocking interface; and if so, determining that the return function cannot be executed.

In at least one embodiment, the control unit 23 is configured to controllably execute the menu function if it is determined that the current user interface is a starting interface or an unlocking interface.

For example, if the current user interface is a starting interface or an unlocking interface, the return function cannot be executed when the return key is pressed. Thus, it is determined that the return function cannot be executed when the return key is pressed. At this time, the output unit 24 outputs a tip of key function adjustment to prompt the user to continue to press the return key, however, the secondary function of the return key is executed. A mode of outputting the tip may be changing the backlight of the return key or outputting a text or voice tip in the user interface. When the user presses the return key again, the menu function is executed. If the current user interface is not a starting interface or an unlocking interface, the return function is still executed when the return key is pressed.

Thus, by means of the terminal according to the embodiment of the present disclosure, at least two-level functions can be triggered through the setting of one key, and the secondary function is executed when it is determined that the primary function cannot be executed, so that the key functions are controlled and the user can operate keys on the terminal flexibly. And the tip of key function adjustment is further output, so as to prompt the user that the key has a function of function control, thereby facilitating the operation of the user.

Referring to FIG. 6 illustrating a schematic structural diagram of yet another terminal according to an embodiment of the present disclosure. As illustrate in FIG. 6, the terminal 3000 includes: at least one processor 31, such as CPU, at least one input device 33, a memory 34, at least one communication bus 32 and at least one display device 35. The communication bus 32 is configured for connection and communication between these components. The input device 33 may include a display and a keyboard. The memory 34 may be a high-speed RAM memory or a non-volatile memory, such as at least one magnetic disk memory. In at least one embodiment, the memory 34 may be at least one storage device located away from the processor 31. The processor 31 may be combined with the terminal as illustrated in FIG. 4 or FIG. 5. A set of program codes are stored in the memory 34, and the processor 31 executes the program codes stored in the memory 34 to:

Monitoring an operation on a first key of a terminal, wherein the operation on the first key at least can trigger a primary function and a secondary function, and the primary function refers to a preset logical function corresponding to the operation on the first key;

Determining whether the operation on the first key can trigger execution of the primary function according to output of a user interface of the terminal; and

If not, controllably executing the secondary function.

In at least one embodiment, the secondary function refers to a preset logical function corresponding to an operation on the second key.

In at least one embodiment, the first key and the second key are arranged symmetrically about a perpendicular bisector in a length direction or a width direction of the terminal.

Furthermore, the processor is further configured to controllably execute the primary function if it is determined that the operation on the first key can trigger the execution of the primary function.

In an optional embodiment, the primary function refers to a menu function, and the secondary function refers to a return function; and

Determining, by the processor 31, whether the operation on the first key can trigger the execution of the primary function according to the output of the user interface of the terminal, includes: determining whether a sub-link or a menu option exists in the current user interface; and if not, determining that the execution of the primary function cannot be triggered.

Furthermore, in this optional embodiment, if it is determined that the operation on the first key cannot trigger the execution of the primary function, controllably executing, by the processor 31, the secondary function, includes: controllably executing the return function if it is determined that no sub-links or menu options exist in the current user interface.

In another optional embodiment, the primary function refers to a return function and the secondary function refers to a menu function; and

Determining, by the processor 31, whether the operation on the first key can trigger the execution of the primary function according to the output of the user interface of the terminal, includes: determining whether the current user interface is a starting interface or an unlocking interface; and if so, determining that the execution of the return function cannot be triggered.

Furthermore, in this another optional embodiment, if it is determined that the operation on the first key cannot trigger the execution of the primary function, controllably executing, by the processor 31, the secondary function, includes: controllably executing the menu function if it is determined that the current user interface is a starting interface or an unlocking interface.

In at least one embodiment, the display device 35 is configured to output a tip of key function adjustment on the display device.

Furthermore, outputting, by the display device 35, the tip of key function adjustment, includes: changing the backlight of the first key on the display device or outputting the tip in the user interface of the display device.

In at least one embodiment, the terminal according to the embodiment can be configured to implement a part or all of the processes in the key function control method embodiment introduced in conjunction with FIG. 1, FIG. 2 or FIG. 3 herein.

Thus, by means of the terminal according to the embodiment of the present disclosure, at least two-level functions can be triggered through the setting of one key, and the secondary function is executed when it is determined that the primary function cannot be executed, so that the key functions are controlled and the user can operate keys on the terminal flexibly.

It should be noted that, for brief description, each of the foregoing method embodiments are described as a combination of a series of operations, however, persons skilled in the art should be aware that the present disclosure is not limited by the sequence of the described operations, since some of the steps may be executed in another sequence or simultaneously according to the present disclosure. Furthermore, persons skilled in the art should be aware that the embodiments described herein are all preferable embodiments in which not all the operations and modules are necessary in the present disclosure.

In the above-mentioned embodiments, the description on them has different focuses. What is not described in detail in a certain embodiment may be derived from relevant contents in other embodiments.

The steps in the methods according to the embodiments of the present disclosure may be merged and removed, and their sequence may be adjusted, according to actual requirements.

The units in the apparatus according to the embodiments of the present disclosure may be merged, divided or removed, according to actual requirements. Persons skilled in the art may combine different embodiments or features in different embodiments described in the present disclosure.

From the description of the foregoing embodiments, persons skilled in the art should be fully aware that the present disclosure may be achieved by hardware, firmware, or a combination thereof. When achieved by software, the foregoing functions may be stored in a computer-readable medium or transmitted as one or more commands or codes on the computer-readable medium. The computer-readable medium includes a computer storage medium and a communication medium. The communication medium includes any medium facilitating transmitting a computer program from one location to another location. The storage medium may be any usable medium accessible by a computer. The computer storage medium includes but is not limited to a Random Access Memory (RAM), a Read-Only Memory (ROM), an Electrically Erasable Programmable Read-Only Memory (EEPROM), a Compact Disc Read-Only Memory (CD-ROM) or other optical disk storage media, magnetic disk storage media or other magnetic storage devices or any other media that can be used to carry or store desired program codes in the form of command or data structure and is accessible by a computer. In addition, any connection may properly serve as a computer-readable medium. For example, if software is transmitted from a website, a server or other remote sources by coaxial cable, optical fiber and cable, UTP, Digital Subscriber Line (DSL) or wireless technologies, such as infrared, radio and microwave, the coaxial cable, the optical fiber and cable, the UTP, the DSL or wireless technologies, such as infrared, radio and microwave are included in the medium. As used by the present disclosure, a disk or disc includes a compact disc, a laser disc, an optical disc, a Digital Versatile Disc (DVD), a floppy disk and a Blue-ray Disc. The disk is generally used to magnetically copy data, while the disc is used to optically copy data with laser. The foregoing combination should also be included within the protection scope of the computer-readable medium.

In summary, the foregoing embodiments are merely preferred embodiments of the present disclosure and are not intended to limit the protection scope of the present disclosure. Any amendments, equivalent substitutions, or improvements and so on within the spirit and principle of the present disclosure should be included within the protection scope of the present disclosure.

1. A key function control method, comprising:
monitoring an operation on a first key of a terminal, wherein the operation on the first key at least can trigger a primary function and a secondary function, and the primary function refers to a preset logical function corresponding to the operation on the first key;
determining whether the operation on the first key can trigger execution of the primary function according to output of a user interface of the terminal; and
controllably executing the secondary function if it is determined that the operation on the first key cannot trigger the execution of the primary function.

2. The method according to claim 1, wherein the secondary function refers to a preset logic function corresponding to an operation on the second key.

3. The method according to claim 1, wherein the first key and the second key are arranged symmetrically about a perpendicular bisector in a length direction or a width direction of the terminal.

4. The method according to claim 1, further comprising:
if it is determined that the operation on the first key can trigger the execution of the primary function, controllably executing the primary function.

5. The method according to claim 1, wherein the primary function refers to a menu function, and the secondary function refers to a return function; and
determining whether the operation on the first key can trigger the execution of the primary function according to the output of the user interface of the terminal, comprises: determining whether a sub-link or a menu option exists in the current user interface; and determining that the execution of the primary function cannot be triggered if it is determined that no sub-links or menu options exist in the current user interface.

6. The method according to claim 5, wherein if it is determined that the operation on the first key cannot trigger the execution of the primary function, controllably executing the secondary function, comprises: controllably executing the return function if it is determined that no sub-links or menu options exist in the current user interface.

7. The method according to claim 1, wherein the primary function refers to the return function and the secondary function refers to the menu function; and
determining whether the operation on the first key can trigger the execution of the primary function according to the output of the user interface of the terminal, comprises: determining whether the current user interface is a starting interface or an unlocking interface; and determining that execution of the return function cannot be triggered if it is determined that the current user interface is a starting interface or an unlocking interface.

8. The method according to claim 7, wherein if it is determined that the operation on the first key cannot trigger the execution of the primary function, controllably executing the secondary function, comprises: controllably executing the menu function if it is determined that the current user interface is a starting interface or an unlocking interface.

9. The method according to claim 1, further comprising outputting a tip of key function adjustment.

10. The method according to claim 9, wherein outputting the tip of key function adjustment, comprises: changing the backlight of the first key or outputting the tip in the user interface.

11-20. (canceled)

21. A terminal, comprising:
a memory storing a set of program codes; and
a processor configured to execute the program codes to:
monitor an operation on a first key of a terminal, wherein the operation on the first key at least can trigger a primary function and a secondary function, and the primary function refers to a preset logical function corresponding to the operation on the first key;
determine whether the operation on the first key can trigger execution of the primary function according to output of a user interface of the terminal; and
controllably execute the secondary function if it is determined that the operation on the first key cannot trigger the execution of the primary function.

22. The terminal according to claim 21, wherein the secondary function refers to a preset logic function corresponding to an operation on the second key.

23. The terminal according to claim 21, wherein the first key and the second key are arranged symmetrically about a perpendicular bisector in a length direction or a width direction of the terminal.

24. The terminal according to claim 21, wherein the processor is further configured to execute the program codes to controllably execute the primary function if it is determined that the operation on the first key can trigger the execution of the primary function.

25. The terminal according to claim 21, wherein the primary function refers to a menu function, and the secondary function refers to a return function; and
the processor is further configured to execute the program codes to determine whether a sub-link or a menu option exists in the current user interface, and determine that the execution of the primary function cannot be triggered if it is determined that no sub-links or menu options exist in the current user interface.

26. The terminal according to claim 25, wherein the processor is further configured to execute the program codes to controllably execute the return function if it is determined that no sub-links or menu options exist in the current user interface.

27. The terminal according to claim 21, wherein the primary function refers to a return function and the secondary function refers to a menu function; and
the processor is further configured to execute the program codes to determine whether the current user interface is a starting interface or an unlocking interface; and determine that execution of the return function cannot be triggered if it is determined that the current user interface is a starting interface or an unlocking interface.

28. The terminal according to claim 17, wherein the processor is further configured to execute the program codes to controllably execute the menu function if it is determined that the current user interface is a starting interface or an unlocking interface.

29. The terminal according to claim 21, wherein the processor is further configured to execute the program codes to output a tip of key function adjustment.

30. The terminal according to claim 19, wherein the processor is further configured to execute the program codes to change the backlight of the first key or output the tip in the user interface.
